(19) United States
(12) Patent Application Publication
(10) Pub. No.: US 2017/0009824 A1
(43) Pub. Date: Jan. 12, 2017

(54) SEMI-AUTOMATIC SYSTEM AND METHOD FOR CONTROLLING CLUTCH OPERATION

(71) Applicant: Oleg DOUNAEVSKY, Hadera (IL)

(72) Inventor: Oleg DOUNAEVSKY, Hadera (IL)

(21) Appl. No.: 14/792,673

(22) Filed: Jul. 7, 2015

(51) Int. Cl. F16D 48/06; F16H 63/46

(52) U.S. Cl. CPC F16D 48/068; F16H 63/46

(57) ABSTRACT

An apparatus for controlling engagement of a clutch comprises at least one distance sensor adapted to provide a signal proportional to the movement of a gear selector in a gearbox along a path for selecting one gear ratio, a clutch engagement control unit adapted to gradually engage the clutch connected to the gearbox in response to the signal of the distance sensor and a clutch signal control unit adapted to receive the signal from the at least one distance sensor and to provide a corresponding control signal to the clutch engagement control unit. A method for controlling the engagement of a clutch comprises receiving a signal proportional to distance of a gear selection lever from the Neutral zone of a gearbox along at least one gear selection path of the gear selection lever and providing a control signal to a clutch control unit to control the engagement of said clutch in response to said signal proportional to the distance of the gear selection lever from the Neutral zone.

### BACKGROUND OF THE INVENTION

Semi-automatic transmission systems have been realized in a number of embodiments. One of the first was SAXOMAT. It had disadvantages as two clutches were needed and it was necessary to push down the gear lever in order to disengage the clutch. Because of its complexity and high cost, this system was discontinued in the nineties of the twentieth century.

U.S. Pat. No. 4,648,290 describes a semi-automatic mechanical transmission control that comprises an up-down shift shaft selector lever and a central processor unit. This system operates automatically but additionally includes a manually operated vehicle master clutch operable by the vehicle operator during start from a standstill. Clear disadvantages of this system are its complexity and necessity of clutch pedal.

U.S. Pat. No. 3,217,846 describes a semi-automatic transmission utilizing a planetary gear unit and a countershaft gear unit and employing a hydraulic actuated clutch. This system features high cost for two gear units and high complexity.

US Patent Application Publication No. 2013/0118857 A1 returns to improved SAXOMAT system. Plurality of patents describes similar inventions featuring complexity and, as result, high cost and low reliability.

### SUMMARY OF THE INVENTION

An apparatus for controlling engagement of a clutch is disclosed, the apparatus comprising at least one distance sensor adapted to provide a signal proportional to the movement of a gear selector in a gearbox along a path for selecting one gear ratio, a clutch engagement control unit adapted to gradually engage the clutch connected to said gearbox in response to the signal of the distance sensor, and a clutch signal control unit adapted to receive said signal from said at least one distance sensor and to provide a corresponding control signal to said clutch engagement control unit.

The clutch engagement control apparatus further comprises, according to some embodiments of the invention, distance sensors adapted to provide, each, a signal proportional to the movement of a gear selector in a gearbox along a respective path for selecting each of the gear ratios for forward and reverse gears.

According to some embodiments, each of said distance sensors in the clutch engagement control apparatus is adapted to provide said proportional signal covering only portion of the gear selection lever path, beginning a distance from the Neutral path of the gear selection lever and ending at the rest position of the respective selected gear ratio.

According to yet additional embodiments, the clutch signal control unit is further adapted to enable selection of a predefined non-linear ratio between the received signal of the distance sensor and the control signal provided to said clutch engagement control unit.

According to yet additional embodiments, the clutch signal control unit is further adapted to provide control signal to said clutch engagement control unit so as to disengage said clutch when a brake pedal is depressed longer than a predetermined time regardless of the position of said gear selection lever.

A method for controlling the engagement of a clutch is disclosed comprising receiving a signal proportional to distance of a gear selection lever from the Neutral zone of a gearbox along at least one gear selection path of said gear selection lever and providing a control signal to a clutch control unit to control the engagement of said clutch in response to said signal proportional to the distance of the gear selection lever from the Neutral zone.

According to some embodiments, the control signal to said clutch control unit is directly linearly proportional to said signal proportional to distance of the gear selection lever from the Neutral zone. According to some additional embodiments of the invention, said control signal to said clutch control unit is directly non-linearly proportional to said signal proportional to distance of the gear selection lever from the Neutral zone. According to some embodiments, the method for controlling engagement of the clutch further comprises providing control signal to said clutch engagement control unit so as to disengage said clutch when a brake pedal is depressed longer than a predetermined time regardless of the position of said gear selection lever.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a system for automatically controlling the operation of a clutch according to some embodiments of the present invention;

FIG. 2A is a schematic illustration of a gear control lever operation sensors assembly, according to some embodiments of the present invention;

FIG. 2B is a schematic illustration of a gear control level travel signal, according to some embodiments of the present invention; and

FIG. 2C is a schematic illustration of clutch control signal in response to gear control lever travel, according to some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although some embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although some embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

Computing device, as described herein below, may include a controller that may be, for example, a central processing unit processor (CPU), a chip or any suitable computing or computational device, an operating system, a memory, a storage, an input devices and an output device(s), e.g., a monitor or display screen. Computing device may carry out embodiments of the present invention.

Operating system as is referred to herein below may be or may include any code segment designed and/or configured to perform tasks involving coordination, scheduling, arbitration, supervising, controlling or otherwise managing operation of a computing device, for example, scheduling execution of programs. Operating system may be a commercial operating system. A memory as referred to herein below may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory unit may be or may include a plurality of, possibly different memory units.

Executable code as referred to herein below may be any executable code, e.g., an application, a program, a process, task or script. The executable code may be executed by a controller possibly under control of an operating system. For example, a controller may execute the executable code which may cause the controller to perform operations described herein below. Where applicable, a processor executing the executable code may carry out operations described herein in real-time. The computing device and the executable code may be configured to update, process and/or act upon information at the same rate the information, or a relevant event, are received. In some embodiments, more than one computing device may be used. For example, a plurality of computing devices that include components similar to those included in a single computing device may be connected to a network and used as a system. For example, controlling the operation of a clutch as described herein, or verifying a session may be performed in real-time by the executable code when executed on one or more computing devices.

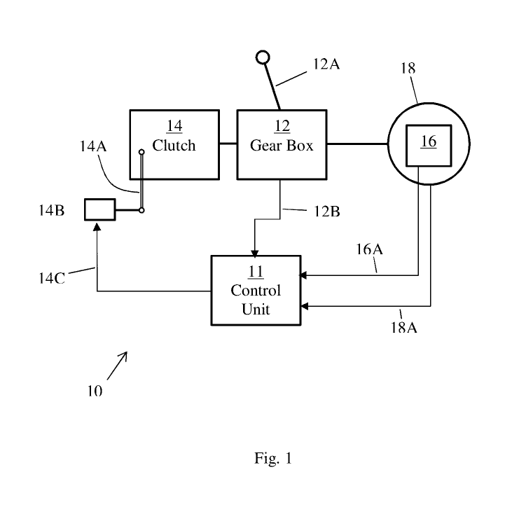

Storage as referred to herein below may be or may include, for example, a hard disk drive, a floppy disk drive, a Compact Disk (CD) drive, a CD-Recordable (CD-R) drive, a universal serial bus (USB) device or other suitable removable and/or fixed storage unit. Content may be stored in the storage unit and may be loaded from the storage unit into a memory unit where it may be processed by a controller. In some embodiments, some of the components shown in FIG. 1 may be omitted.

Input devices as referred to herein below may be or may include a mouse, a keyboard, a touch screen or pad, distance sensors (on/off or proportional), operation sensors (operated/not-operated), speed proportional sensors, or any suitable input device. It will be recognized that any suitable number of input devices may be operatively connected to the computing. Output devices as referred to herein below may include one or more actuators (linear, rotational and the like), displays, speakers and/or any other suitable output devices. It will be recognized that any suitable number of output devices may be operatively connected to the computing. Any applicable input/output (I/O) devices may be connected to the computing device.

Some embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein.

According to some embodiments of the present invention, a high reliability semi-automatic system for gear and clutch control is disclosed. Reference is made now to FIG. 1, which is a schematic illustration of system 10 for automatically controlling the operation of a clutch in a manual gear driving system, according to embodiments of the present invention. Control system 10 may comprise control unit 11, gear lever position and travel sensors signals unit 12, clutch control actuator 14B to operate clutch lever 14A of clutch unit 14, brake operation unit 16 to provide brake operation signal 16A and travel speed signal unit 18 to provide travel speed signal 18A.

Control unit 11 may be any control or computing unit capable of receiving signals, of executing, according to some embodiments, stored programs in response to the received signals and to provide clutch control signal in response to the received signals and according to the executed programs and stored data and configuration. Control unit 11 may comprise computing unit (not shown) such as a CPU, a controller and the like, as is known in the art. Control unit 11 may further comprise non-transitory memory (not shown) capable of storing data and programs for operating by the computational unit. Control unit 11 may further comprise input-output (I/O) unit (not shown) adapted to receive signals and provide control signal as s described in details herein below. I/O unit may further be adapted to enable communication of control unit 11 with external communication unit, for example for enabling setup adjustments and debugging of the operation of system 10, as is known in the art.

Control unit 11 may receive signals 12B indicating, each, the position of gear selection lever 12A with respect to its respective gear selection, i.e. forward gears 1-5, reverse gear R or idle position. The lever position signals 12B may be proportional to the location of the lever 12A in the respective gear selection path when the user moves gear selection lever 12A to its new selection position, or when the user pulls lever 12A from a selection towards the idle zone.

Control unit 11 may further receive brake 16 operational status signal 16A, indicative of the operational position (operated/not-operated) status of brake 16.

Control unit 11 may further be adapted to receive signal 18A indicative of the travel speed of a vehicle carrying system 10 (or, alternatively, rotation speed of wheel 18).

Control unit 11 may be adapted to provide proportional actuating signal 14C to actuator 14B, adapted to operate clutch lever 14A proportionally from fully disengaged to fully engaged and vice versa. Clutch actuator 14B may be any suitable actuator, linear, rotational or otherwise, as is known in the art. It would be apparent that control unit may be realized, according to embodiments of the present invention, without use of a computing unit, and/or memory unit. For example, control unit may be a transducer adapted to receive the various 206A(x) signals and produce a single clutch control signal such as signal 212 or 14(c), which is proportional to the magnitude of the one active input signal 206A, or is equal to substantially zero when no input signal 206A is active (i.e. providing sensible reading).

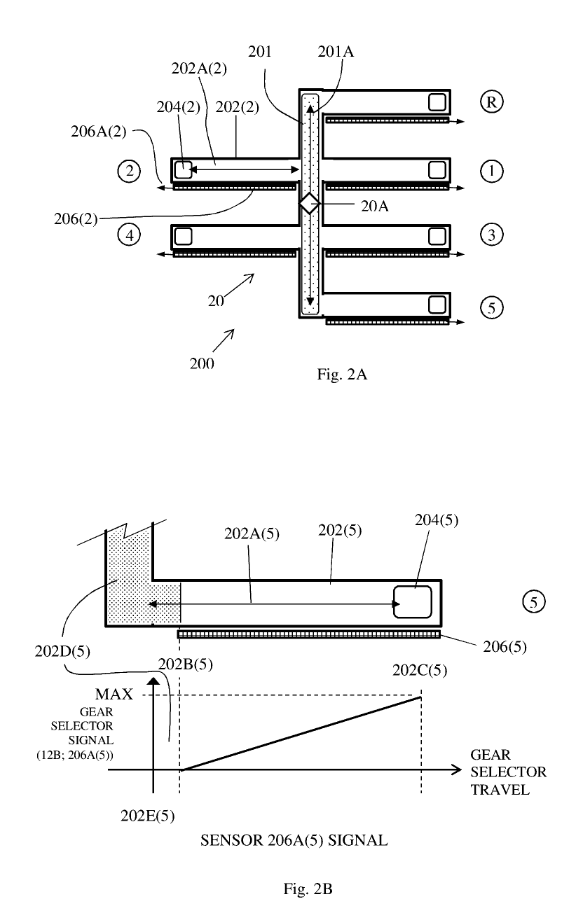

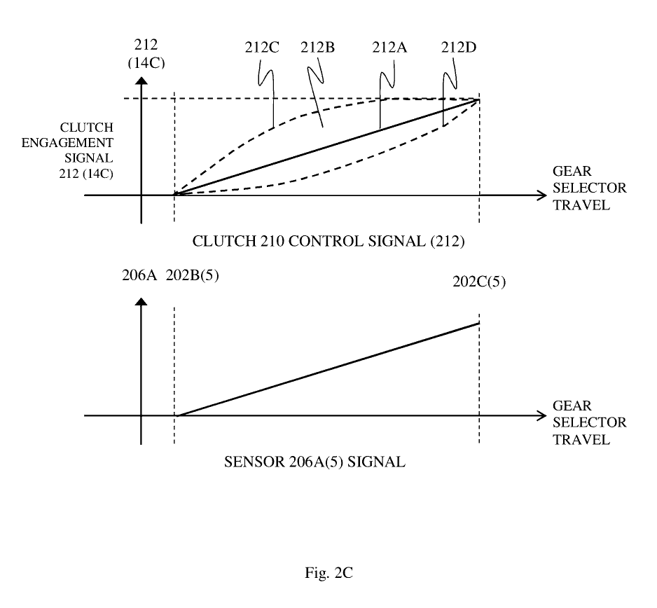

Reference is made now to FIG. 2A, which is a schematic illustration of a gear control lever operation sensors assembly 200, according to embodiments of the present invention and to FIG. 2B, which is a schematic illustration of a gear control lever travel signal 12A, according to embodiments of the present invention.

FIG. 2A depicts gear control lever operation sensors assembly 200 comprising typical manual gear selection system 20, as seen by a user of a vehicle. Gear selection system 20 controls the selection of one of 5 available forward gears (denoted 1-5), one reverse gear (denoted R) and neutral zone 201 which, when gear selection lever 20A is in it, for example anywhere along two-headed arrow 201A, the gear is in un-engaged status. For the sake of clarity elements in FIG. 2A were drawn but not all of them are numbered. It would be apparent that for elements related to the portion of gear 2 of assembly 200 the following elements are drawn and all of them are marked, on the rightmost end of the reference number, with “(2)”, denoting that this element refers to the sub-assembly of gear “2”. Similar elements, of other gear selections, will carry the respective gear number in parenthesis on their rightmost end. For gear selection no. 2 the gear selection path along which gear selection lever 20A travels from Neutral position to final rest position 204(2) is denoted 202(2) and the travel distance along which is denoted 202A(2). Sensor 206(2) may be installed, for example, alongside path 202(2) so as to be able to measure and provide proportional signal 206A(2), indicative of the location of gear selection handle 20A along path 202A(2).

Assembly 200 may further comprise, for at least some of the paths of lever 20A towards some of the gear selection positions 204, location sensor 206 to measure and provide proportional signal 206A(2), providing signal 12A (FIG. 1) indicative of the position of gear selection lever along the respective path range 202A, from the respective neutral/dead zone position (such as 202D of FIG. 2B) to the respective gear selection rest point 204. According to some embodiments, signal 12B may be a linear function of the gear selection travel along path 202, as seen in the graph of FIG. 2B. Yet, it would be apparent to those skilled in the art that other kinds of function may represent the ratio between the location of lever 12A (FIG. 1), 20A and the magnitude of signal 12B, for example a slightly convexed or slightly concaved graphs, expressing non-linear signal function.

The sensitivity and/or operational range of sensor 206 may be adapted, or tuned, to provide readable signal 12B only beginning a certain distance from the Neutral zone, thus providing dead zone of distance sensitivity to block system 200 from providing signals when gear selector lever 20A travels back and forth along the Neutral travel path 201A. Accordingly, gear selection lever position signal 12B begins to provide readable values only from point 202B and, according to the linear signal graph of FIG. 2B, ends at its maximum value, when lever 20A reaches its gear selection rest point 204. However, as indicated above, the relation between the location of lever 20A along path 202 may be represented by a non-linear graph, as may be the case. Sensors 206 may be installed next to the handle of gear selection lever, next to the entry of the selection lever to the gearbox, or anywhere else, as the case may be, considering the required accuracy of the sensitivity of sensors 206, as well as the convenience of installation onto existing manual gear control systems Similarly, sensing of the location of gear selection lever may be done using other types of sensors, being placed, optionally in different locations with respect to the gear selection lever, or other mechanisms involved in gear selection in the gearbox.

Each of gear selection position signals 206A(1)-206A(5) and 206A(R) may be provided to control unit a control unit, such as control unit 11 (FIG. 1), collectively denoted 12B in FIG. 1. According to the schematic description of system 200, it will be apparent that only one of the lever position signals may have a value other than zero (0) at any time, and that when the selection lever is in the Neutral zone or in any of dead zones 202D none of signals 206A will provide an input signal.

Reference is made now to FIG. 2C, which is a schematic illustration of clutch control signal in response to gear control lever travel, according to embodiments of the present invention. In order to automatically control the operation of clutch in a manual gear vehicle, such as clutch 14 of FIG. 1, control unit, such as control unit 11 of FIG. 1, may send proportional control signal, such as signal 14C of FIG. 1, to proportionally control the position of clutch control lever 14A by clutch control actuator 14B, between full engagement to full disengagement of clutch 14. According to certain embodiments of the present invention, whenever gear selection lever is in the Neutral zone, such as zone 201 of FIG. 2A, or in one of the dead zones 202D of FIG. 2B the magnitude of any of signals 206A that are received from sensors 206 is substantially zero or at least negligible. Accordingly, control unit, such as control unit 11, may send control signal such as control signal 14C of FIG. 1, that will position clutch lever 14A in the disengaged position, at least for certain duration T_{Disengage}_{_}_{delay}. If, after the lapse of this time duration, no gear was yet selected, the control unit may send engage signal to clutch actuator 14B, in order to prevent excessive wear of the clutch. When one gear selection signal 206A is received, the control unit may send disengagement signal to the clutch actuator (or ensure the clutch is disengaged), in order to enable smooth and silent engagement of the selected gear.

The relation between the signal 211 (or 206A of FIG. 1) representing the location of gear selection lever 20A as it progresses along its respective path 202, towards its rest position 204 or towards the dead zone 202D, and the signal 212 (or 14C in FIG. 1) sent to actuator 14B may be linear relation, as depicted by line 212A, or may be another function, for example a graph drawn within the grey area 212B residing between lines 212C and 212D of FIG. 2C. Graph 212A expresses linear actuation of clutch 14 as a response to the progress of gear selection lever 20A towards rest position 204 or from it. Accordingly, the rate of engagement of clutch 14 will be constant along the travel of gear selection lever 20A, leaving the sensitive engagement for such relation in the hands of the user of system 200. Proper selection of the relation between the progress of gear selection lever 20A and the signal 212 (or 14C) to actuator 14B of clutch 14 may provide ‘soft’ engagement or ‘hard/‘sportive’ engagement of clutch 14, as may be required to the user of system 200 Similarly, the relation between signal 206A and signal 212 on the way of gear selection lever away from rest position 204 towards dead zone 202D may be according to another relation graph to provide operational curve different from that used during engagement of the clutch when a certain gear is left on the way to a different gear or to the Neutral zone.

According to some yet additional embodiments, control unit 11 may receive signal 16A indicative of the operational status of brake 16 (braking/not braking) on the vehicle of system 10 and further control unit 11 may receive signal 18A indicative of the speed 18 of whether the vehicle to enable system 10 to identify when the vehicle is not in motion. Based on the readings 16A from brake 16 and 18A from wheel 18, control unit 10 may identify a stationary situation of the vehicle, when brake 16 is operated and the travel speed is zero, that lasts longer than a predefined period of time T_{STAND}_{_}_{STILL} after which control unit may issue disengagement signal to clutch 14 even if one of the gears was selected, in order remove unnecessary mechanical loads from clutch 14 and/or brake 16 and/or the engine of the vehicle. Any change of the readings of signals 206A, 16A or 18A may cause control unit to re-assess the command to clutch 14 in order to decide whether a change in the control signal 14C is required.

It will be appreciated that, according to some embodiments of the present invention, the response curve of system 10 in terms of the engagement/disengagement feeling of clutch 14 may be tuned to meet user's demands and nature of driving. Actually any one of the response curves, of each of the gears, may be tuned to meet the user's requirements.

In the case of general failure of system 10, backup pedal for manual operation of the clutch may be enabled by, for example, releasing it from its stowed position (not shown) thus further increasing the reliability of system 10.

Some embodiments of the invention as described above enable a user to easily and for cheap modify a regular manual gear control vehicle into a semi-automatic vehicle by automatically operating the clutch in response to manual gear selection/gear changing by the user.

Implementation of a control system, such as control system 10 of FIG. 1, on a regular vehicle with manual gear control system may be easy, straight forward and cheap, compared with other such systems known in the art, since it does not require installation of expensive and hard to install components, as is the case with prior art systems.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. An apparatus comprising:
at least one distance sensor adapted to provide a signal proportional to the movement of a gear selector in a gearbox along a path for selecting one gear ratio;
a clutch engagement control unit adapted to gradually engage the a clutch connected to said gearbox in response to the signal of the distance sensor; and
a clutch signal control unit adapted to receive said signal from said at least one distance sensor and to provide a corresponding control signal to said clutch engagement control unit.

2. The apparatus of claim 1, further comprising distance sensors adapted to provide, each, a signal proportional to the movement of a gear selector in a gearbox along a respective path for selecting each of the gear ratios for forward and reverse gears.

3. The apparatus of claim 2 wherein each of said distance sensors is adapted to provide said proportional signal covering only portion of the gear selection lever path, beginning a distance from the Neutral path of the gear selection lever and ending at the rest position of the respective selected gear ratio.

4. The apparatus of claim 3, wherein said clutch signal control unit is further adapted to enable selection of a predefined non-linear ratio between the received signal of the distance sensor and the control signal provided to said clutch engagement control unit.

5. The apparatus of claim 4, further adapted to provide control signal to said clutch engagement control unit so as to disengage said clutch when a brake pedal is depressed longer than a predetermined time regardless of the position of said gear selection lever.

6. A method for controlling a clutch comprising:
receiving a signal proportional to distance of a gear selection lever from the Neutral zone of a gearbox along at least one gear selection path of said gear selection lever; and
providing a control signal to a clutch control unit to control the engagement of said clutch in response to said signal proportional to the distance of the gear selection lever from the Neutral zone.

7. The method of claim 6 wherein said control signal to said clutch control unit is directly linearly proportional to said signal proportional to distance of the gear selection lever from the Neutral zone.

8. The method of claim 6 wherein said control signal to said clutch control unit is directly non-linearly proportional to said signal proportional to distance of the gear selection lever from the Neutral zone.

9. The method of claims 7 to 8 further comprising:
providing control signal to said clutch engagement control unit so as to disengage said clutch when a brake pedal is depressed longer than a predetermined time regardless of the position of said gear selection lever.
